(19) United States
(12) Patent Application Publication
(10) Pub. No.: US 2023/0015798 A1
(43) Pub. Date: Jan. 19, 2023

(54) STEERING CONTROL DEVICE AND METHOD

(71) Applicant: MANDO CORPORATION, Gyeonggi-do (KR)

(72) Inventor: Tae Sik KIM, Gyeonggi-do (KR)

(21) Appl. No.: 17/847,666

(22) Filed: Jun. 23, 2022

(30) Foreign Application Priority Data
Jul. 19, 2021 (KR) 10-2021-0094206

(51) Int. Cl. B62D 6/00

(52) U.S. Cl. CPC B62D 6/008; B62D 5/006

(57) ABSTRACT

The disclosure relates to a steering control device and method. According to the disclosure, a steering control device comprises a receiver receiving a steering angle and a steering torque of a steering wheel and a reaction force generator calculating a breaking torque based on the steering angle and steering torque of the steering wheel and a reaction torque corresponding to the steering angle of the steering wheel and outputting a command current to allow a reaction force motor to output the calculated breaking torque.

### CROSS-REFERENCE TO RELATED APPLICATION

This application claims priority from Korean Patent Application No. 10-2021-0094206, filed on July 19, 2021, which is hereby incorporated by reference for all purposes as if fully set forth herein.

### BACKGROUND

### Field

The present embodiments relate to a steering control device and method for generating a breaking torque in a driver's steering.

### Description of Related Art

Vehicle steering assist systems include hydraulic steering assist systems that steers the vehicle by generating hydraulic pressure by a pump and electric steering assist systems that steer the vehicle by a motor.

The vehicle steering assist system is required to provide the driver with an appropriate steering sensation depending on the driving context to allow the driver to feel the steering of the vehicle as the driver holds and turns the steering wheel. Such a steering feeling may be provided by a reaction force motor connected with the steering wheel through, e.g., the column.

Recently, steer-by-wire systems are adopted in vehicles to electrically drive the vehicle wheels without mechanical connections between the steering wheel and the wheels. The steer-by-wire system performs vehicle steering by operating the steering motor connected to the wheels under the control of the electronic control unit (ECU) detecting the rotation signal of the steering wheel.

### BRIEF SUMMARY

In the above background, according to the disclosure, there is provided a steering control device and method that may reduce the load on the reaction force motor, controlled by a high current, by generating a reaction torque using an elastic member, thereby reducing the FETs connected with the reaction force motor.

To achieve the foregoing objectives, in an aspect, the disclosure provides a steering control device comprising a receiver receiving a steering angle and a steering torque of a steering wheel and a reaction force generator calculating a breaking torque based on the steering angle and steering torque of the steering wheel and a reaction torque corresponding to the steering angle of the steering wheel and outputting a command current to allow a reaction force motor to output the calculated breaking torque.

In another aspect, the disclosure provides a steering control method comprising a steering information reception step receiving a steering angle and a steering torque of a steering wheel, a breaking torque calculation step calculating a breaking torque based on the steering angle and steering torque of the steering wheel and a reaction torque corresponding to the steering angle of the steering wheel, and a breaking torque generation step outputting a command current to allow the reaction force motor to generate the calculated breaking torque.

According to the disclosure, the steering control device and method may reduce the load on the reaction force motor, controlled by a high current, by generating a reaction torque using an elastic member, thereby reducing the FETs connected with the reaction force motor.

### DESCRIPTION OF DRAWINGS

The above and other objects, features, and advantages of the present disclosure will be more clearly understood from the following detailed description, taken in conjunction with the accompanying drawings, in which:

FIG. 1 is a block diagram illustrating a steering assist system according to an embodiment;

FIG. 2 is a block diagram illustrating a steering control device according to an embodiment of the disclosure;

FIG. 3 is a cross-sectional view of a stopper for describing an example in which a steering input actuator 30 generates a reaction torque according to an embodiment;

FIG. 4 is a view illustrating a breaking torque according to an embodiment;

FIGS. 5A and 5B are views illustrating an inverter generating a breaking torque according to an embodiment;

FIG. 6 is a view illustrating an example of generating a breaking torque according to a duty ratio according to an embodiment;

FIG. 7 is a view illustrating an example of generating a breaking torque according to a steering condition and a return condition according to an embodiment;

FIG. 8 is a flowchart illustrating a steering control method according to an embodiment of the disclosure; and

FIG. 9 is a view illustrating, in detail, step S830 according to an embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, a steering control device according to an embodiment of the disclosure is described with reference to the accompanying drawings.

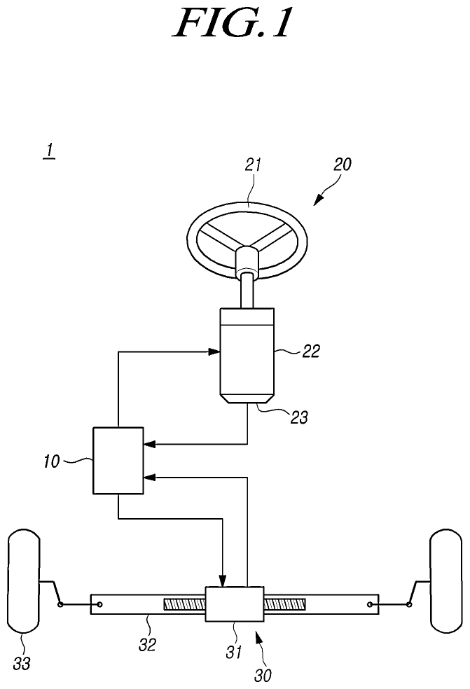

FIG. 1 is a block diagram illustrating a steering assist system according to an embodiment.

The steering assist system 1 may include hydraulic power steering (HPS), which generates hydraulic pressure by rotating a pump to provide steering assist force, and electronic power steering (EPS), which drives a motor to provide steering assist force, depending on driving types. The following description focuses primarily on the electronic steering assist system 1, but the disclosure is not limited thereto.

The steering assist system 1 may be a mechanical steering assist system 1, which steers the wheel 33 by transferring the force (torque) generated by the driver turning the steering wheel 21 to the steering motor 23 via a mechanical power transmission device (e.g., linkage) to steer the wheel 223 by the driving of the steering motor 23, or a steer-by-wire (SbW) system, which transfers power by transmitting/receiving electric signals through, e.g., a cable, instead of a mechanical power transmission device, depending on whether the steering input actuator 20 and the steering output actuator 30 is coupled through a mechanical connecting member (or linkage). An example in which the steering assist system 1 is an SbW system is described below, but the disclosure is not limited thereto.

The steering assist system 1 according to the disclosure, as shown in FIG. 1, may include a steering input actuator 20, a steering control device 10, and a steering output actuator 30. As described above, if the steering assist system 1 is an SbW system, the steering input actuator 20 and the steering output actuator 30 may be mechanically separated from each other.

The steering input actuator 20 may mean a device to which steering information intended by the driver is inputted. As described above, the steering input actuator 20 may include a steering wheel 21, a steering shaft 22, and a reaction force motor 23 and may further include a steering angle sensor or a steering torque sensor.

The reaction force motor 23 may receive a control signal (or referred to as a ‘command current’) from the steering controller 10 and apply a reaction force to the steering wheel 21. Specifically, the reaction force motor 23 may receive a command current from the steering controller 10 and drive at a rotation speed indicated by the command current, generating reaction torque.

The steering control device 10 may receive steering information from the steering input actuator 20, calculate a control value, and output an electrical signal indicating the control value to the steering output actuator 30. The steering information may mean information including at least one of a steering angle or a driver torque (also referred to as a steering torque).

Meanwhile, the steering control device 10 may receive, as feedback, power information actually output from the steering output actuator 30, calculate a control value, and output an electrical signal indicating the control value to the steering input actuator 20, providing the driver with a steering sensation (steering feeling).

The steering control device 10 may be implemented as, e.g., an electronic control unit (ECU).

According to an embodiment, a computer system (not shown), such as the steering control device 10, may be implemented as an electronic control unit (ECU). The ECU may include at least one or more of one or more processors, a memory, a storage unit, a user interface input unit, or a user interface output unit which may communicate with one another via a bus. The computer system may also include a network interface for accessing a network. The processor may be a central processing unit (CPU) or semiconductor device that executes processing instructions stored in the memory and/or the storage unit. The memory and the storage unit may include various types of volatile/non-volatile storage media. For example, the memory may include a read only memory (ROM) and a random access memory (RAM).

The steering output actuator 30 may mean a device that actually drives the steering of the vehicle. The steering output actuator 30 may include a steering motor 31, a rack 32, a wheel 33, and the like, and may further include a vehicle velocity sensor, a rack position sensor, and the like.

The steering motor 31 may axially move the rack 32. Specifically, the steering motor 31 may receive a command current from the steering controller 10 and thus drive, and may allow the rack 32 to linearly move in the axial direction.

As driven by the steering motor 31, the rack 32 may perform a linear motion which allows the wheels 33 to turn to the left or right.

Although not shown, the steering assist system 1 according to an embodiment may further include, e.g., a clutch for separating or connecting the steering input actuator 20 and the steering output actuator 30. The clutch may be operated by the control of the steering control device 10.

If the steering assist system 1 according to the disclosure is an SbW system, and the vehicle travels in an autonomous driving mode, the steering assist system 1 according to an embodiment may control only the steering output actuator to perform steering control on the vehicle or may control both the steering input actuator 20 and the steering output actuator 30 to perform steering control on the vehicle.

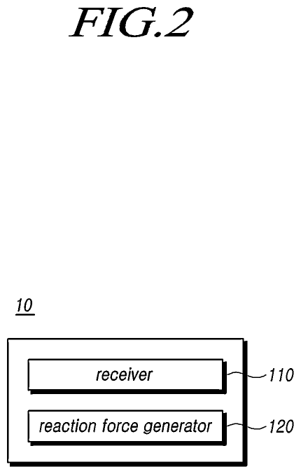

FIG. 2 is a block diagram illustrating a steering control device 10 according to an embodiment of the disclosure.

Referring to FIG. 2, a steering control device 10 according to an embodiment of the disclosure may include a receiver 110 and a reaction force generator 120.

The receiver 110 may receive the steering angle and steering torque of the steering wheel 21. Specifically, the receiver 110 may receive the steering angle detected by the rotation steering angle sensor of the steering wheel 21, included in the steering input actuator 20 and the steering torque resultant from detecting the twist of the torsion bar by the steering torque sensor, from the respective sensors.

The reaction force generator 120 may calculate the breaking torque based on the reaction torque corresponding to the steering angle of the steering wheel 21, the steering torque, and the steering angle of the steering wheel 21 and output a command current to generate the calculated breaking torque to the reaction force motor 23.

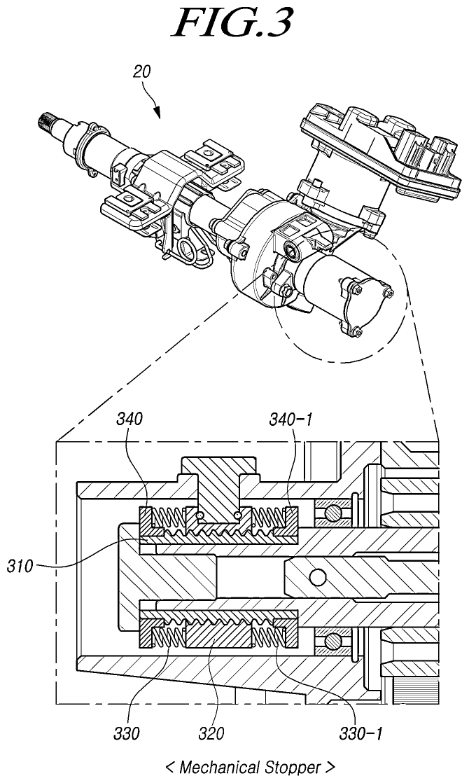

FIG. 3 is a cross-sectional view of a stopper for describing an example in which a steering input actuator 30 generates a reaction torque according to an embodiment.

Referring to FIG. 3, the reaction torque may be generated as a nut 320, which is moved in the direction of the rotation axis along the rotation direction of the steering wheel 21 in conjunction with the rotation of the steering wheel 21, receives an external force by elastic members 330 and 330-1 positioned in the moving path of the nut 320, inside the stopper.

The nut 320 may be mounted on the thread of a lead screw rotated with the steering wheel 21. Accordingly, if the steering wheel 21 is rotated, the lead screw 310 connected with the steering wheel 21 may be rotated and, if the lead screw 310 is rotated, the nut 320 may be moved in the direction of the rotation axis of the nut 320, i.e., the length direction of the lead screw 310, along the rotation direction of the steering wheel 21 by the thread of the lead screw 310.

The steering wheel 21 may control the steering of the vehicle and, since the steering of the vehicle may have a limit to the angle for implementing steering, the steering wheel 21 may be implemented to be rotated up to the angle limit that may be implemented by the vehicle.

To implement this, dampers 340 and 340-1 may be formed on two opposite ends of the nut 320, which moves in the direction of the rotation axis of the lead screw 310, to prevent further movement of the nut 320. Accordingly, although the steering wheel 21 continues to rotate in one direction, the nut 320 moved in conjunction with the steering wheel 21 is restricted for its movement by the damper 340, implementing a steering angle limit of the steering wheel 21.

In other words, the elastic members 330 and 330-1 are positioned on two opposite ends of the nut 320 in the rotation axis along which the nut 320 is moved and apply a tensile or compressive force to the nut 320 in the neutral direction of the nut 320.

The steering control device 10 according to the disclosure may implement a reaction torque by the elastic member 330 positioned in the moving path of the nut 320.

Referring to FIG. 3, for example, the elastic member 330 may be mounted in the direction along which the damper 340 faces the nut 320. Since the dampers 340 and 340-1 are positioned on two opposite sides of the nut 320, the same number of elastic members 330-1 as the number of elastic members 330 mounted on one side surface of the nut 320 may be mounted on the opposite side surface of the nut 320. As the nut 320 is moved to the elastic member 330, the elastic member 330 may generate a tensile force or compressive force in the opposite direction to the moving direction of the nut 320.

As another example, a plurality of elastic members 330 may be mounted on the outer circumferential surface of the lead screw 310 in the direction from one surface of the damper 340 facing the nut 320 to the nut 320.

As another example, the elastic members 330 may be mounted, with the lead screw 310 interposed therebetween. In other words, two elastic members 330 may be mounted on one side surface and its opposite side surface of the nut 320.

The above-described elastic member 330 may be, e.g., a spring. However, without limited thereto, the elastic member is not limited to a spring but may be any elastic member that may generate a tensile force or compressive force in the direction opposite to the moving direction of the nut 320.

However, when the nut 320 reaches the neutral position by the tensile force or compressive force generated by the above-described elastic member 330, the remaining tensile force or compressive force may continuously be applied to the nut 320 without disappearing by inertia.

To prevent such overshooting, the disclosure may control the reaction force motor 23 to offset the above-described residual-tensile force or compressive force.

The stopper structure according to FIG. 3 is merely an example and is not limited to a specific type of spring damper as long as it may generate a reaction torque by utilizing the tensile force of the spring.

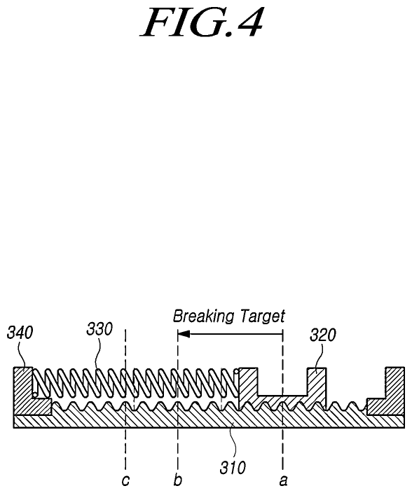

FIG. 4 is a view illustrating a breaking torque according to an embodiment.

Referring to FIG. 4, the elastic member 330 compressed as the nut 320 moves may apply the compressive force to the nut 320 so that the nut 320 is positioned neutral, i.e., the position of the steering wheel 21 becomes neutral. However, the compressive force may remain without disappearing due to inertia when the nut 320 reaches the neutral position b, so that the nut 320 may arrive at position a, i.e., overshooting.

This phenomenon may degrade the driver's steering feeling by generating unexpected reaction torque.

To prevent such overshooting, the steering control device 10 according to the disclosure may control the reaction force motor 23 to generate a breaking torque from the neutral position a to position b, thereby minimizing the overshooting range. In other words, in the overshooting range, the steering control device 10 according to the disclosure may generate a breaking torque in the direction opposite to the direction of the compressive force.

If the breaking torque generated to minimize the above-described overshooting range is excessive, the nut 320 may move up to position c beyond the neutral position a, so-called underdamping. To minimize underdamping, the reaction force generator 120 may generate a preset breaking torque in the underdamping range, e.g., position c. As such, the breaking torque values corresponding to the steering angles of the steering wheel 21 or each position of the nut 320 may be preset.

Although position b should be the neutral position of the nut 320, i.e., the middle of the moving range of the nut 320, it is shown as positioned off to the left for convenience of description.

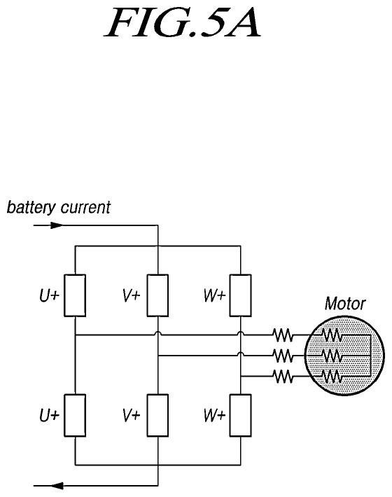

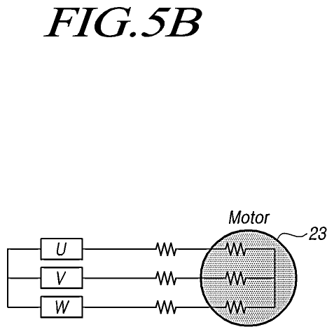

FIGS. 5A and 5B are views illustrating an inverter generating a breaking torque according to an embodiment.

Referring to FIG. 5A, the structure of an inverter for controlling a general reaction force motor 23 may be configured as shown in FIG. 5A.

Specifically, to implement a waveform, e.g., s sine wave, two field effect transistors (FETs) may be connected to each phase of the three-phase motor to be operated complementary to each other. If the reaction force motor 23 is controlled through at least six FETs, a reaction force is generated by receiving a high current from the battery. Thus, power consumption may be significant.

To reduce power consumption, the elastic members 330 may be mounted inside the stopper to generate a reaction torque by a tensile force or compressive force as described above, and the inverter structure as shown in FIG. 5B may be configured to minimize overshooting.

Specifically, in the inverter structure as shown in FIG. 5B, one or more FETs may be connected to each phase of the three-phase motor to serve only as a switch. Further, without receiving power from the battery, the power generated as the reaction force motor 23 is rotated in the direction opposite to the rotation of the steering wheel 21 is used to generate a breaking torque. The FETs connected to each phase may be powered by the battery, and the on/off control of the FET may be performed by the reaction force generator 120.

As described above, the steering control device 10 of the disclosure may generate a reaction torque through the elastic members 330 and generate a breaking torque by three FETs, thereby reducing FETs and hence costs and power consumption.

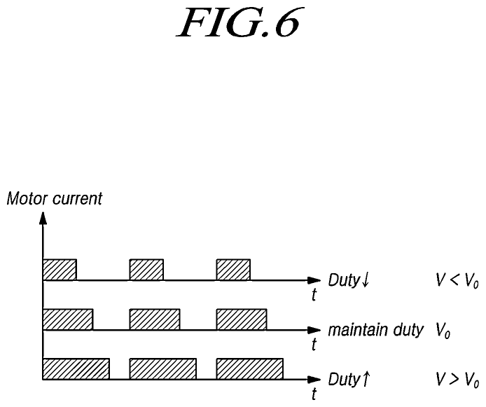

FIG. 6 is a view illustrating an example of generating a breaking torque according to a duty ratio according to an embodiment.

The reaction force generator 120 may set a duty ratio of the reaction force motor 23 based on the velocity of the host vehicle. To that end, the receiver 110 may further receive the velocity of the host vehicle from the vehicle velocity sensor of the steering output actuator 30.

Referring to FIG. 6, the reaction force generator 120 may increase the duty ratio of the reaction force motor 23 as the velocity of the host vehicle increases. Specifically, if the velocity of the host vehicle exceeds a predetermined velocity, the reaction force generator 120 may control the reaction force motor 23 to generate a breaking torque at a higher duty ratio than the duty ratio set for the predetermined velocity. In contrast, if the velocity of the host vehicle is less than the predetermined velocity, the reaction force generator 120 may control the reaction force motor 23 to generate a breaking torque at a duty ratio lower than the duty ratio set for the predetermined velocity. The preset velocity may be the velocity of the host vehicle measured by the vehicle velocity sensor at a previous time (or previous scan).

The duty ratio may be implemented by controlling the FETs connected to each phase of the reaction force motor 23 through pulse width modulation (PWM).

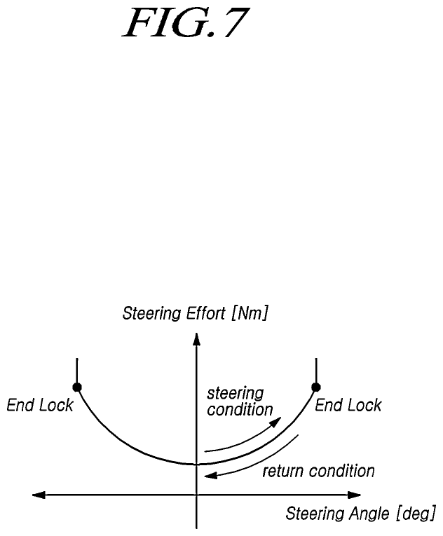

FIG. 7 is a view illustrating an example of generating a breaking torque according to a steering condition and a return condition according to an embodiment.

The reaction force generator 120 may determine whether the steering wheel 21 is steered based on the steering angle and the steering torque and generate a breaking torque based on the determination of whether the steering wheel 21 is steered.

Referring to FIG. 7, in general, steering condition may mean controlling the steering wheel 21 to move to two opposite ends of the rack. In other words, the steering condition may be moving the steering wheel 21 in the direction along which the absolute value of the steering angle increases.

In contrast, return condition may mean controlling the steering wheel 21 to move to the middle of the rack. In other words, the return condition may be moving the steering wheel 21 in the direction along which the absolute value of the steering angle decreases.

As the steering angle of the steering wheel 21 increases (or as the steering angle decreases if the steering angle is less than 0), the steering torque required to control the steering wheel 21 increases. Thus, in the context where the steering angle returns to 0, the steering torque value may be small or zero.

Given this, the reaction force generator 120 may determine that the case where the steering angle is changed, and a steering torque value is detected is the steering condition and may determine that the case where the steering angle is changed, and no steering torque value is detected is the return condition. In this case, under the steering condition, the reaction force generator 120 may generate a small breaking torque value or no breaking torque and, under the return condition, the reaction force generator 120 may generate a breaking torque.

In an embodiment, the reaction force generator 120 may determine whether the steering wheel 21 is steered based on the steering angle and the steering angular velocity and generate a breaking torque depending on whether the steering wheel 21 is steered.

If the steering wheel 21 is positioned at a steering angle clockwise from the neutral position of the steering wheel 21, and the steering angular velocity is clockwise, and if the steering wheel 21 is positioned at a counterclockwise steering angle, and the steering angular velocity is counterclockwise, the reaction force generator 120 may determine that the above-described case is the steering condition.

If the velocity of the host vehicle is lower than a preset velocity under the steering condition, i.e., if the velocity of the host vehicle is a low velocity, the reaction force generator 120 may generate no breaking torque. Further, if the velocity of the host vehicle under the steering condition is higher than the preset velocity, i.e., high velocity, the reaction force generator 120 may generate a breaking torque.

If the steering wheel 21 is positioned at a steering angle counterclockwise from the neutral position of the steering wheel 21, and the steering angular velocity is clockwise, and if the steering wheel 21 is positioned at a counterclockwise steering angle, and the steering angular velocity is clockwise, the reaction force generator 120 may determine that the above-described case is the return condition.

If the velocity of the host vehicle under the return condition is lower than the preset velocity, the reaction force generator 120 may generate a breaking torque and set the duty ratio to be lower than the duty ratio corresponding to the preset velocity. In other words, the reaction force generator 120 may set a duty ratio corresponding to the low velocity of the host vehicle.

In contrast, if the velocity of the host vehicle under the return condition is higher than the preset velocity, the reaction force generator 120 may generate a breaking torque and set a duty ratio corresponding to the above-described velocity.

The above-described elastic member 330 may be affected by the wire diameter, outer diameter, number of turns, free field length, elastic modulus of the material, etc. which may be applied as variables for calculating the breaking torque.

Further, in producing a breaking torque function, inductance, resistance, and counter electromotive voltage constant may be applied to circuit b of FIG. 5.

The above-described steering control device 10 may be applied to both belt-and-pulley type steering input actuators 20 and worm-and-worm wheel type steering input actuators 20.

Described below is a steering control method using the steering control device 10 capable of performing the above-described embodiments of the disclosure.

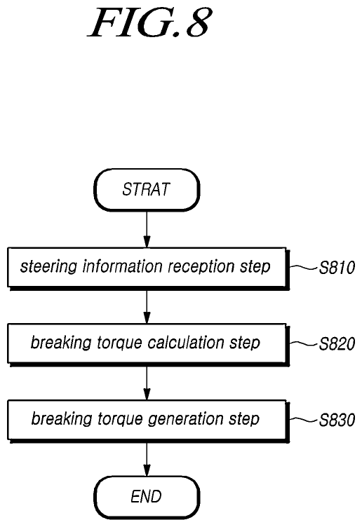

FIG. 8 is a flowchart illustrating a steering control method according to an embodiment of the disclosure.

Referring to FIG. 8, according to the disclosure, a steering control method may comprise a steering information reception step S810 of receiving a steering angle and a steering torque of a steering wheel 21, a breaking torque calculation step S820 of calculating a breaking torque based on the steering angle and steering torque of the steering wheel 21 and a reaction torque corresponding to the steering angle of the steering wheel 21, and a breaking torque generation step S830 of outputting a command current to the reaction force motor 23 to allow the reaction force motor 23 to generate the calculated breaking torque.

The reaction torque may be generated as a nut 320, which is moved in the direction of the rotation axis along the rotation direction of the steering wheel 21 in conjunction with the rotation of the steering wheel 21, receives an external force by elastic members 330 positioned in the moving path of the nut 320. In other words, the elastic members 330 are positioned on two opposite ends of the nut 320 in the rotation axis along which the nut 320 is moved and apply a tensile or compressive force to the nut 320 in the neutral direction of the nut 320. In one example, the elastic member 330 may be a spring and may apply an elastic force of the spring to the nut 320 so that the nut 320 moves to the neutral position of the nut 320.

In the reaction force motor 23, one or more FETs may be connected to each phase of the reaction force motor 23.

The breaking torque generation step S930 may determine whether the steering wheel 21 is steered based on the steering angle and the steering torque and generate a breaking torque based on the determination of whether the steering wheel 21 is steered.

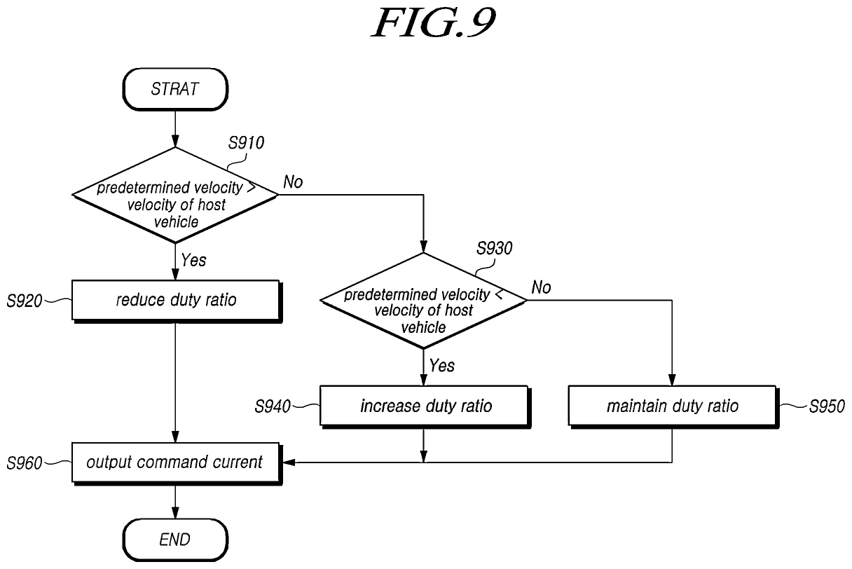

FIG. 9 is a view illustrating, in detail, step S830 according to an embodiment.

Referring to FIG. 9, the steering control device 10 may determine whether the velocity of the host vehicle is smaller than a predetermined velocity (S910). The steering control device 10 may receive the velocity of the host vehicle from the vehicle velocity sensor included in the steering output actuator 30 and compare the received velocity with a predetermined velocity.

If the velocity of the host vehicle is smaller than the predetermined velocity (Yes in S910), the steering control device 10 may reduce the duty ratio of the reaction force motor 23 (S920). Accordingly, a breaking torque may be generated according to the reduced duty ratio until a duty ratio adjusted by receiving a next velocity of the host vehicle is applied.

If the velocity of the host vehicle is equal to or larger than the predetermined speed (No in S910), the steering control device 10 may determine whether the velocity of the host vehicle is larger than the predetermined velocity (S930).

If the velocity of the host vehicle is larger than the predetermined velocity (Yes in S930), the steering control device 10 may increase the duty ratio of the reaction force motor 23 (S940).

If the velocity of the host vehicle is equal to the predetermined velocity (No in S930), the steering control device may maintain the existing duty ratio set in the reaction force motor 23.

The steering control device 10 may output a command current including the set duty ratio (S960).

The above-described predetermined velocity may be the velocity of the host vehicle detected at a previous time. The so-set duty ratio may increase as the velocity of the host vehicle increases.

As described above, according to the disclosure, the steering control device and method may reduce the load on the reaction force motor 23, controlled by a high current, by generating a reaction torque using the elastic member 330, thereby reducing the FETs connected with the reaction force motor 23.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A steering control device, comprising:
a receiver receiving a steering angle and a steering torque of a steering wheel; and
a reaction force generator calculating a breaking torque based on the steering angle and steering torque of the steering wheel and a reaction torque corresponding to the steering angle of the steering wheel and outputting a command current to allow a reaction force motor to output the calculated breaking torque.

2. The steering control device of claim 1, wherein the reaction torque is generated as a nut moved in a direction of a rotation axis along a rotation direction of the steering wheel in conjunction with rotation of the steering wheel receives an external force by elastic members positioned in a moving path of the nut.

3. The steering control device of claim 2, wherein the elastic members are positioned on two opposite ends of the rotation axis along which the nut is moved and applies a tensile force or compressive force to the nut in a neutral direction of the nut.

4. The steering control device of claim 1, wherein one or more field effect transistors (FETs) are connected to each phase of the reaction force motor.

5. The steering control device of claim 1, wherein the receiver further receives a velocity of a host vehicle, and
wherein the reaction force generator sets a duty ratio of the reaction force motor based on the velocity of the host vehicle.

6. The steering control device of claim 5, wherein the reaction force generator increases the duty ratio of the reaction force motor as the velocity of the host vehicle increases.

7. The steering control device of claim 1, wherein the reaction force generator determines whether the steering wheel is steered based on the steering angle and the steering torque and generates the breaking torque based on the determination of whether the steering wheel is steered.

8. A steering control method, comprising:
a steering information reception step receiving a steering angle and a steering torque of a steering wheel;
a breaking torque calculation step calculating a breaking torque based on the steering angle and steering torque of the steering wheel and a reaction torque corresponding to the steering angle of the steering wheel; and
a breaking torque generation step outputting a command current to allow the reaction force motor to generate the calculated breaking torque.

9. The steering control method of claim 8, wherein the reaction torque is generated as a nut moved in a direction of a rotation axis along a rotation direction of the steering wheel in conjunction with rotation of the steering wheel receives an external force by elastic members positioned in a moving path of the nut.

10. The steering control method of claim 9, wherein the elastic members are positioned on two opposite ends of the rotation axis along which the nut is moved and applies a tensile force or compressive force to the nut in a neutral direction of the nut.

11. The steering control method of claim 8, wherein one or more field effect transistors (FETs) are connected to each phase of the reaction force motor.

12. The steering control method of claim 8, wherein the steering information reception step further receives a velocity of a host vehicle, and
wherein the breaking torque generation step sets a duty ratio of the reaction force motor based on the velocity of the host vehicle.

13. The steering control method of claim 12, wherein the breaking torque generation step increases the duty ratio of the reaction force motor as the velocity of the host vehicle increases.

14. The steering control method of claim 8, wherein the breaking torque generation step determines whether the steering wheel is steered based on the steering angle and the steering torque and generates the breaking torque based on the determination of whether the steering wheel is steered.
